(19) United States
(12) Patent Application Publication
(10) Pub. No.: US 2025/0242434 A1
(43) Pub. Date: Jul. 31, 2025

(54) Method for operating a laser plotter for cutting, engraving, marking and/or lettering a workpiece, and a laser plotter for engraving, marking and/or lettering a workpiece

(71) Applicant: Trotec Laser GmbH, Marchtrenk (AT)

(72) Inventor: Matthias Jörgl, Marchtrenk (AT)

(21) Appl. No.: 18/854,485

(22) PCT Filed: Mar. 21, 2023
(86) PCT No.: PCT/AT2023/060081

§ 371 Date: Oct. 4, 2024

(30) Foreign Application Priority Data
Apr. 8, 2022 (AT) A50228/2022

(51) Int. Cl. B23K 26/042; B23K 26/352

(52) U.S. Cl. CPC B23K 26/042; B23K 26/352

(57) ABSTRACT

A laser plotter and method for operating a laser plotter for cutting, engraving, marking and/or lettering a workpiece are disclosed. When an irradiation source is activated, a laser beam is directed via deflection elements to a focusing unit. A control unit performs the control on the basis of set parameters and/or a loaded job. The data, in particular job, are received via a computer unit, and a calculation of the path planning is performed offline by the computer unit or externally by a cloud solution or component. The path planning and other data are transferred to a PLC controller or soft PLC, from which at the sampling times, the individual target data, in particular the path planning and other data, such as the speed, are then sent step by step via an industrial bus to at least the modules for axle control and laser control.

### TECHNICAL FIELD

The present disclosure relates to a method for operating a laser plotter for cutting, engraving, marking and/or lettering a workpiece, as well as a laser plotter for engraving, marking and/or lettering a workpiece.

### DESCRIPTION OF THE RELATED ART

DE 102004043175 A1 discloses a method for predetermining the processing position of a laser beam, in which a laser head is attached to a robot arm, whereby the point of impact of the laser beam on the surface of the workpiece is tracked with a camera. Here the actual position of the laser beam is derived from the camera position, and a processing position is determined from the deviation between the target position and the corresponding actual position.

Furthermore, laser machines or laser plotters in which one or more irradiation sources, in particular lasers, are operated are already known from the prior art. To this end, a laser beam is sent from the irradiation source via deflection elements to a focusing unit, whereby the laser beam is deflected in the focusing unit in the direction of the workpiece and preferably focused via an optical element, in particular a lens. The individual components, in particular the laser control modules, the axle modules, the exhaust system, the camera, etc., are controlled by a control unit developed in-house, which processes the set and transmitted parameters or a transmitted job.

In conventional architectures, it is common for the laser control module to be connected directly to the position encoders of the axle modules or axle controller, as a stand-alone control and setup solution is used. This ensures that a laser pulse is triggered in good time when a predetermined axle position is reached, i.e. that the laser control module is constantly informed about the actual position of the working head, in particular the focusing unit, through the connection with the position encoder and thus the laser or laser pulse is activated in good time in order to carry out laser processing of the workpiece at the desired or predetermined position of the working head, in particular the focusing unit.

The disadvantage here is that the stand-alone solution requires high effort in terms of hardware and software engineering in the development of a laser machine, in particular a laser plotter.

### SUMMARY OF EMBODIMENTS

The objective of the present disclosure is to provide a method for operating a laser plotter for cutting, engraving, marking and/or inscribing a workpiece, as well as a laser plotter for this purpose, in which on the one hand the above-mentioned disadvantages are avoided and on the other hand a standardized structure is achieved.

The objective is achieved by the disclosed embodiments. Advantageous embodiments and/or process measures are described in the dependent claims.

The objective of the present disclosure is achieved by a method for operating a laser plotter for cutting, engraving, marking and/or lettering a workpiece, in which the data, in particular job, are received via a computer unit, and a calculation of the path planning is performed offline by the computer unit or externally by a cloud solution or by a component, whereupon the path planning and other data are transferred to a PLC controller or soft PLC (26b), from which at the sampling cycles or sampling times, the individual target data, in particular the path planning and other data, such as the speed, are then sent step by step via an industrial bus, in particular an EtherCat bus, to at least the modules for axle control and laser control, where at least the detected position and speed information, in particular the axle positions and speeds, are sent from the axle module to the laser control module at the cyclic sampling times, whereupon an estimate or calculation of one or several future axle positions at future points in time is performed by the laser control module or by a universal board, in particular by the Universal Trotec Board, in order to activate a control signal for the laser control in good time, in particular for activating the laser at the predetermined estimated axle position of the focusing unit.

The advantage here is that the estimate of the positions or axle positions makes it possible for the first time to use a standardized industrial bus for such a laser machine, in particular a laser plotter, without any loss of quality, as the laser can always be activated at the right time by “estimating” the position of the focusing unit. Usually, the sampling time or the sampling cycle of standardized industrial buses is much too high or not deterministically equal to be suitable for synchronization of the laser with the axle position of the focusing unit, i.e. the position of the focusing unit when transmitting the data, especially the measured or detected axle positions, is much too early at the sampling times to activate the laser. According to the present disclosure, this is solved in such a way that an estimate of the axle positions is carried out between the sampling times or sampling cycles, so that an axle position can be determined at future points in time at which the laser must be activated in order to hit the workpiece at the desired location or position, i.e. that position data are generated or calculated in a period of time, which are used to trigger the laser pulse. Thus, the high sampling time due to the position estimates has no effect. This means that the laser is synchronized with the axle position based on the estimates.

Advantageous embodiments are such in which the axle module cyclically transfers or transmits the position and speed data received from a position sensor and the next axle position according to the calculated path planning to the laser control module via the industrial bus at the sampling time. This ensures that a planned final value is available for the simulation or calculation of the estimate, so that the direction of the calculation, in particular whether the calculation increases or decreases, is specified. Hence, always only a slight deviation from the planned path results.

Advantageous embodiments are also such in which the laser control module or the universal board, in particular the Universal Trotec Board, performs a calculation or estimate of several future system states, in particular the future axle position at future points in time, on the basis of a numerical time integration method, in particular the Runge-Kutta 4 method, on the basis of the data transferred by the axle modules. This makes it possible to make do with an integration process that has proven itself in the prior art. Hence, simple software integration is ensured.

Further advantageous embodiments are such in which the number of future calculated estimates, in particular the calculated axle position at future calculated points in time, is adjustable or can be adjusted. This means that the number of estimates can be easily adjusted for different applications. The quality of the laser processing increases with the number of estimates set, as the time and axle position for triggering the control signal to activate the laser is given more precisely. If fewer estimates are set, the time increment Δt between the individual points in time increases, which means that the control signal for the laser can no longer be triggered as precisely. The lasers used have a laser frequency of 200 kHz, for example, so that with a sampling time of 200 μs of the industrial bus, 40 different estimates can be made or calculated in the best case, i.e. at the highest resolution, i.e. an estimate of the axle position can be made every 5 μs.

Advantageous embodiments are such in which at the start of the simulation period the estimate corresponds exactly to the measurement or the transmitted axle position, whereby a difference between the planned axle position and the simulated axle position arises as the simulation time progresses. This ensures that in every case only a very small difference or deviation between the estimated axle position and the planned axle position results. The simulation period is the time between two sampling times of the industrial bus.

However, advantageous embodiments are also those in which the difference is automatically corrected by adopting the measured or known axle position at each sampling time. This ensures that the axle position is automatically corrected after each sampling time so that there is only ever a slight difference in the deviation. Here, the position sent at the start of an estimate is used as the new position for the estimate.

Advantageous embodiments are also those in which the time of the PLC control or soft PLC is synchronized with the time of the modules, in particular the axle control or axle module and laser control or laser control module or universal Trotec board. The PLC controller or Soft PLC sends out synchronization information so that the PLC clock runs synchronously with the slave clocks, in particular the axle modules and laser control module.

However, advantageous embodiments are also those in which the sampling time for the industrial bus used, in particular the EhterCat-Fast bus, is between 150 μs and 300 μs, in particular 200 μs. This ensures that data are transmitted from master to slave or slave to slave or slave to master depending on the sampling time.

Advantageous embodiments are such in which the time span between the points in time for estimating the axle position, in particular several points in time, is smaller than the time span between the sampling times is. This ensures that at least one, preferably several, points in time between the sampling times are used for the estimate or calculation of the axle position.

Advantageous embodiments are such in which the deviation of the estimate of the axle position depends on the accuracy of the measurement of the initial state and/or on the choice of the effects taken into account in the model and/or on the accuracy of the numerical values used for the model parameters for, among other things, geometry, inertia, friction and elasticity and/or on the simulation duration. This ensures that the deviation of the estimate from the planned or actual axle position can be kept to a minimum due to the parameters included.

Advantageous embodiments are such in which at the sampling times (40) a result of the path planning, in particular position, speed, acceleration, laser power, etc., is transmitted. This ensures that the essential information on the sampling times is always transferred.

Furthermore, the objective of the present disclosure is achieved by a laser plotter for engraving, marking and/or lettering a workpiece, in which a computer unit is arranged for the transfer and processing of data, in particular jobs or graphics and/or text, which is connected to a PLC controller or soft PLC, where at least one axle module and one laser control module are connected to the PLC controller or soft PLC via an industrial bus, where the laser control module or the universal board, in particular the Universal Trotec Board, is designed to estimate or calculate future axle positions at future points in time based on recorded position and speed information, in particular the axle positions and speeds of the axle modules, whereupon a laser can be activated at a correspondingly defined axle position.

The advantage here is that by estimating axle positions at future points in time, the times with correspondingly estimated axle positions are shortened in such a way that for the first time it is possible to operate a laser plotter with a PLC controller or Soft PLC and an industrial bus.

Advantageous embodiments are such in which the position encoder is arranged on the axle module. This ensures that standardized modules can be used. This avoids the costs of developing expensive stand-alone solutions.

Finally, embodiments are advantageous in which the, preferably Windows-based, computer unit is integrated into the laser plotter. This enables simple data connection with external components.

The problem with using an industrial bus is that the sampling time for transmitting data is far too long or the time span between the samplings is too long to be able to control the laser according to the transmitted axle position, since when using standardized components, in particular a PLC control system or a soft PLC and industrial bus, the position encoder of the axle module is not directly connected to the laser control module, so that the laser control module receives the information, in particular the axle positions, only at the sampling times. However, since the sampling time is too long, an application without a solution according to the present disclosure for estimating the axle positions is not possible. The estimate of the axle position ensures that the time for generating a control signal for the laser can be determined as accurately as possible. Thus, the estimate or calculation of the axle positions simulates a synchronization of the laser control module or the universal board, in particular the Universal Trotec Board, with the position encoder of the axle module. In contrast, the prior art uses a stand-alone solution in which the position sensor is directly connected or coupled to the laser control module so that the laser control module is constantly informed about the position of the focusing unit and can therefore generate the control signal for activating the laser in good time.

The present disclosure is then described in the form of an exemplary embodiment, whereby it is pointed out that the disclosed embodiments are not limited to the illustrated and described embodiment example or solution, but can be transferred to equivalent solutions.

### BRIEF DESCRIPTION OF THE DRAWINGS

The figures show:

FIG. 1 is a schematic illustration of a laser machine, in particular a laser plotter, for processing a workpiece with a camera system on the lid-simplified, for illustrative purposes only;

FIG. 2 is a block diagram of the laser plotter controller with a computer unit and PLC control-simplified, for illustrative purposes only;

FIG. 2a is another block diagram of the laser plotter control with a soft PLC in the computer unit-simplified, for illustrative purposes only;

FIG. 3 is a schematic representation of the calculation of an estimate between two sampling cycles;

FIG. 4 is a schematic representation of several estimates in several successive sampling cycles.

By way of introduction, it should be noted that in the various embodiments, identical parts are provided with identical reference signs or identical component designations, respectively, and the disclosures contained in the entire description can be applied mutatis mutandis to identical parts with identical reference signs or identical component designations, respectively. The positional information selected in the description, such as top, bottom, side, etc., likewise refers to the figure described and is to be transferred to the new position mutatis mutandis in the event of a change of position.

### DETAILED DESCRIPTION OF EMBODIMENTS

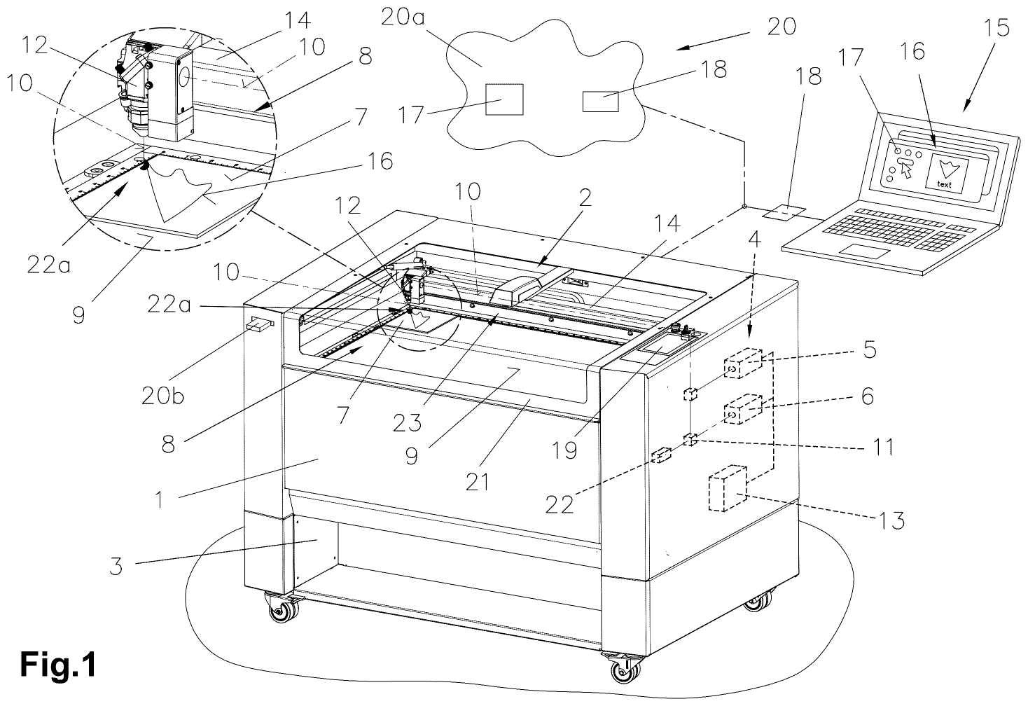

FIGS. 1 to 4 show an exemplary embodiment of a laser machine 1, in particular a laser plotter 1, in which, for example, a camera system 2 is integrated and a method for operating a laser plotter 1 for cutting, engraving, marking and/or lettering a workpiece carried out.

In the laser plotter 1 shown, at least one, preferably two, irradiation sources 4 or laser sources 4 in the form of lasers 5, 6 are arranged in a housing 3. The lasers 5 and 6 preferably act in alternating fashion on a workpiece 7 to be processed. The workpiece 7 is positioned in a processing chamber 8 of the laser plotter 1, in particular on a processing table 9, whereby the processing table 9 is preferably height-adjustable. A laser beam 10 emitted by an irradiation source 4, in particular the laser 5 or 6, is sent via deflection elements 11 to at least one movable focusing unit 12, from which the laser beam 10 is deflected in the direction of the workpiece 7 and focused for processing. Control, in particular the position control of the laser beam 10 in relation to the workpiece 7, is carried out via software running in a control unit 13, whereby the workpiece 7 is processed by adjusting a carriage 14, on which the focusing unit 12 is also movably arranged, preferably via a belt drive in X-Y direction. Here it is possible, for example, that in the “engraving” machining process, the carriage 14 is moved line by line, whereas in the “cutting” machining process, the carriage 14 is moved according to the contour to be cut, i.e. not line by line.

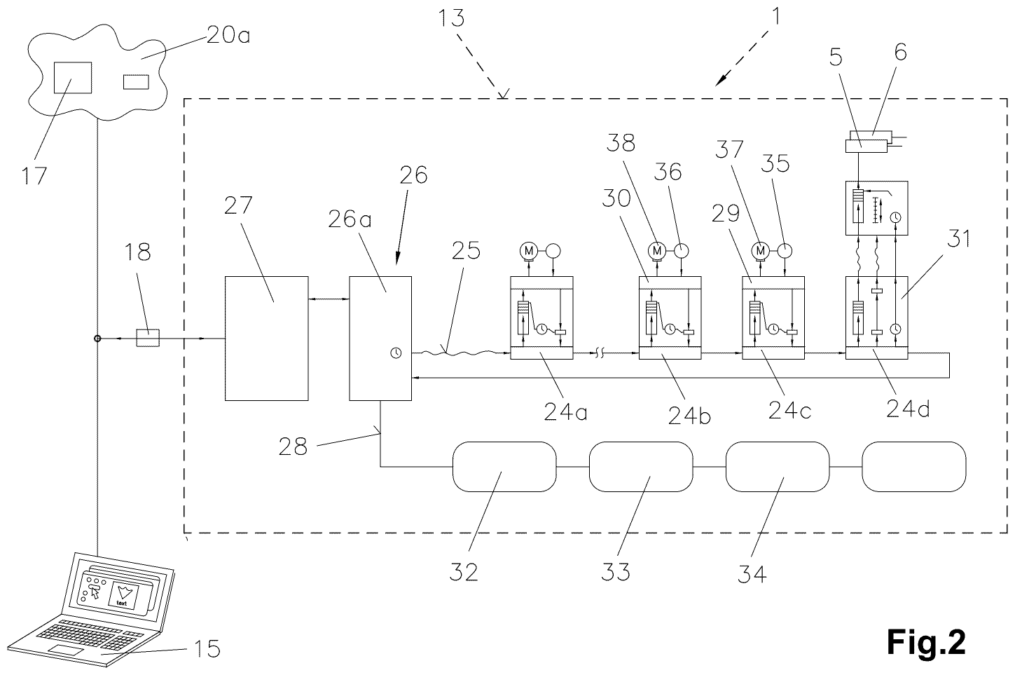

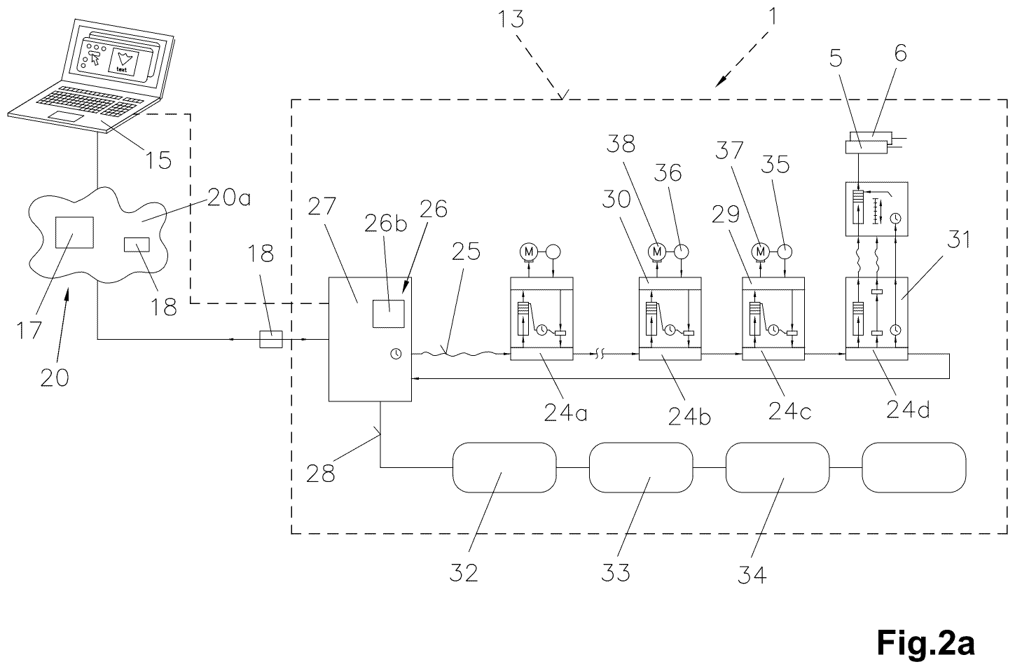

On an external component 15, in particular a computer, laptop or a control unit, a graphic 16 and/or a text 16 is created or loaded, respectively, using a commercially available software 17, such as CorelDraw®, Paint®, etc., or a proprietary application software 17, in particular Ruby® 17, which is exported or transferred, respectively, to the control unit 13 of the laser machine or laser plotter 1 preferably in the form of a job 18. Preferably, the data to be transferred are converted by the same or a different software so that the control unit 13 can process the job 18. Alternatively, the data can be converted by software in the control unit 13 or in a cloud solution. Of course, it is also possible for the input to be made directly on the laser plotter 1 using available input means 19, such as a touchscreen 19 or input buttons, or for a corresponding job 18 to be loaded from a storage medium 20, such as a cloud 20a, a USB stick 20b, etc. After the data, in particular the job or jobs 18, have been transferred or created directly or loaded from the storage medium 20, the laser machine 1, in particular its control unit 13, processes the job 18. Here it is possible for several jobs 18 to be stored simultaneously in the laser machine 1, in particular the laser plotter 1, and processed sequentially. It should be mentioned that the application software 17, in particular Ruby® 17, can also be invoked via the cloud 20a, so that the graphic 16 and/or text 16 can be created via the cloud 20a, i.e. the application software 17, in particular Ruby® 17, is installed in the cloud 20a and can be invoked from a web browser on a computer, so that the graphic 16 and/or text 16 can then be created or loaded, whereupon a job 18 is created for the laser plotter 1, which is sent directly to the laser plotter 1 or can be stored in the cloud 20a so that it can be loaded at a later time, as shown by way of example in FIG. 2a, whereby a direct connection of the computer 15 to the laser machine 1 is also shown in dotted lines.

With such laser machines 1, in particular laser plotters 1, it is necessary for safety reasons that a cover 21 or door 21, which is preferably at least partially transparent, must be closed to start a job 18 to be processed in which the laser beam 10 acts on the workpiece 7, as shown in FIG. 1. The operating staff can then manually or alternatively automatically position the laser dot or a laser pointer 22, in particular laser pointer dot 22a, which is coupled into the laser beam path 5,6 and is deflected in the direction of the processing table 8 via the focusing unit 12, on the inserted workpiece 7, whereupon the job 18 for processing the workpiece 7 can be started. At the end of the job 18, the carriage 14 and the focusing unit 12 are then preferably moved to the starting position so that the finished workpiece 7 can be removed, whereupon a new machining process can be started by inserting a new workpiece 7 or blank 7, respectively, to be machined. It is advantageous if the end of processing is indicated visually or acoustically so that the user does not have to constantly monitor the laser machine 1. For the sake of completeness, it is mentioned that the focusing unit 12 can also be adjusted with the laser pointer 22 activated when the lid 21 is open, but the laser 5, 6 cannot be activated.

It is also possible that at least one camera 23 is provided in the camera system 2, whereby the camera 23 is located in the cover 21. The camera 23 is designed to record the processing chamber 8, in particular the processing table 9, so that an inserted workpiece 7 can be detected. However, it is also possible for two or more cameras 23 to be arranged in the cover 21 or housing 3. The position of the inserted workpiece 7 is captured by the camera 23 and preferably displayed on the external component, in particular the laptop. The position of the workpiece 7 is preferably captured before machining or the start of the machining process, so that the focusing unit 12 can be positioned accordingly via the laser pointer 22. For the sake of completeness, it should be noted that the position of the workpiece 7 can also be detected when the lid 21 is open.

The novel laser plotter 1 or laser machine 1 now includes a novel electronic architecture, in particular the structure of the control unit 13, as can be seen schematically in a block diagram in FIGS. 2 and 2a.

For this purpose, the control unit 13 now includes several preferably standardized modules, which are connected as so-called slaves 24 (24a, b, c, d, . . . ) to a master 26 via an industrial bus 25, in particular an EtherCat bus 25, whereby the master 26 is formed by a standardized PLC controller 26a, as shown in FIG. 2, or soft PLC 26b, as shown in FIG. 2a. In order to enable transfer of data to the master 26, the same is connected to a computer unit 27 or integrated directly into the computer unit 27. The computer unit 27 can in turn be connected via a data connection to an external component 15, in particular a laptop, or storage medium 20, so that the created job 18 or the created or loaded graphic 16 and/or text 16 can be transferred to the computer unit 27 in the laser plotter 1, i.e. a job 18 or a graphic and/or text 16 is received by the computer unit 27 from the external component 15, in particular laptop 15, or a storage medium 20, in particular the cloud 20a, whereupon the computer unit 27 processes the received data. A path planning, in particular a calculation of the paths and/or positions of the focusing unit 12 and/or the movement sequences/patterns of the focusing unit 12 and/or a result, including positions, speeds, accelerations, laser powers, etc. of the path planning, for processing the workpiece 7 is carried out by the computer unit 27 or externally by a cloud solution or offline by the component 15, so that all positions, paths, speeds, accelerations and laser activations, laser powers, etc. are known at the start of the work process. The path planning is then transferred from the computer unit 27 to the PLC controller 26a or soft PLC 26b, in particular the master 26, whereupon the path planning, in particular the paths and/or positions and/or movement sequences/patterns and/or results, is then applied to the industrial bus 25 step by step at the sampling cycles 40 or sampling times 40, i.e. the path planning is calculated offline by the computer unit 27 or externally by a cloud solution or component 15 and transferred to the master 26, in particular the PLC controller 26a or soft PLC 26b, which then transfers the first results of the path planning, in particular position, speed, acceleration, laser power, etc., to the slaves 24 at the sampling times 40 or sampling cycles 40, whereupon the next result of the path planning and so on are transmitted at the next sampling cycle 40 or the next sampling time 40. Synchronization information is also transmitted so that the slave times are synchronized with the master time. Preferably, a Windows-based computer unit 27 is used, although other operating systems, such as Linux, macOS, etc., can also be used. The computer unit 27 is preferably implemented as a PC (personal computer), so that simple external communication with the components 15 or storage medium 20 is possible. Here, a wired and/or wireless connection, for example Ethernet, WLAN, etc., to the storage medium 20, in particular to the cloud 20a, and/or the external component 15 can be used.

In the illustrated exemplary embodiment, the master 26 or the PLC controller 26a or soft PLC 26b has two industrial buses 25 and 28, whereby one industrial bus 25 (EtherCat-Fast) has a fast sampling time 40 of approx. 200 μs and the other industrial bus 28 (EtherCat. Slow) has a much slower sampling time. The slaves 24 are thus connected to the two industrial buses 25 and 28 as required, whereby the axle controllers 29, 30 or axle modules 29, 30 for at least the X and Y axles and the laser controller 31 or the laser control module 31 are connected to the fast industrial bus 25 (EtherCat-Fast). The other slaves 24 or modules 32-34, such as the safety module 32, the input/output module 33, the feed axle module 34, etc. do not require such a fast cyclical sampling time 40, so that they can be connected to the slower industrial bus 28 (EtherCat-Slow). Of course, it is possible that a PLC controller 26a or soft PLC 26b can be used or operated with only one industrial bus 25 or 28, so that all modules 29-34 are controlled via this one industrial bus 25 or 28. It is also possible to arrange the laser control module 31 on a universal board, in particular a Universal Trotec Board, on which other components or modules can also be arranged, which can, for example, take over individual work steps of the laser control module 31, whereby time delays are prevented here by the direct connection via the universal board.

Use of standardized components, in particular the PLC controller 26a or soft PLC 26b with the industrial bus 25,28 (EtherCat), does not allow shortening of the sampling time 40 for sending and receiving data. This high sampling time 40 of standardized industrial buses 25,28 means that the laser 5,6 is fired either much too early or too late to a desired axle position, in particular the position of the focusing unit 12, so that quality, in particular engraving quality, suffers as a result. With the industrial bus 25 EtherCat-Fast used, the fastest possible sampling time 40 is 200 μs, so data can be sent and received only every approx. 200 μs, i.e. only at the sampling time 40 or the sampling cycle 40, i.e. every approx. 200 μs, the recorded position and speed information of the axle modules 29,30 can be transmitted to the laser control module 31 for activating the lasers 5,6, whereby activation of the laser 5,6 requires only a fraction of the sampling time 40, so that the laser 5,6 would be fired much too early if the positions were transmitted without the solution according to the disclosed embodiments.

To correctly control the laser control module 31 for firing or activating the laser 5,6 during processing of the workpiece 7, in particular in engraving mode, it is necessary that the control signal for the laser control module 31 is synchronized with the position of the working head or focusing unit 12, in particular with the axle module 29,30. In conventional laser plotters 1 known from the prior art, it is common for the laser control module 31 to be electrically connected directly to the position sensors 35, 36 of the axle modules 29, 30. This ensures that a laser pulse is triggered in good time when a predefined position is reached, in particular a few us beforehand, so that the laser 5,6 is also activated at the exact time when the position of the working head is reached, in accordance with the path planning.

Due to the use of standardized components, the laser plotter 1 according to the present disclosure has no direct connection between the position encoder 35, 36 of the axle modules 29, 30 and the laser control module 31. The position encoder 35, 36 of an axle or drive 37, 38 is connected to the axle module 29, 30, where the position information is available, so that the same can be sent only according to the sampling time 40, i.e. the position and speed information is transmitted cyclically via the industrial bus 25 from the axle module 29, 30 to the laser control module 31 at the sampling time 40, so the actual position of the axles or the focusing unit 12 is always known to the laser control module 31 at the sampling time 40. However, the sampling time 40 for standardized industrial buses 25 is too long to ensure that the laser control module 31, in particular the laser 5, 6, is activated in good time when a certain position is reached. The lower limit of the sampling time 40 is defined by technical conditions such as computing speed, transmission time, transmission delay and is approx. 200 μs with the EtherCat bus used, so that the measured position of the position sensors 35, 36 and other information, such as speed, acceleration, laser power, etc., can only be transmitted every approx. 200 μs.

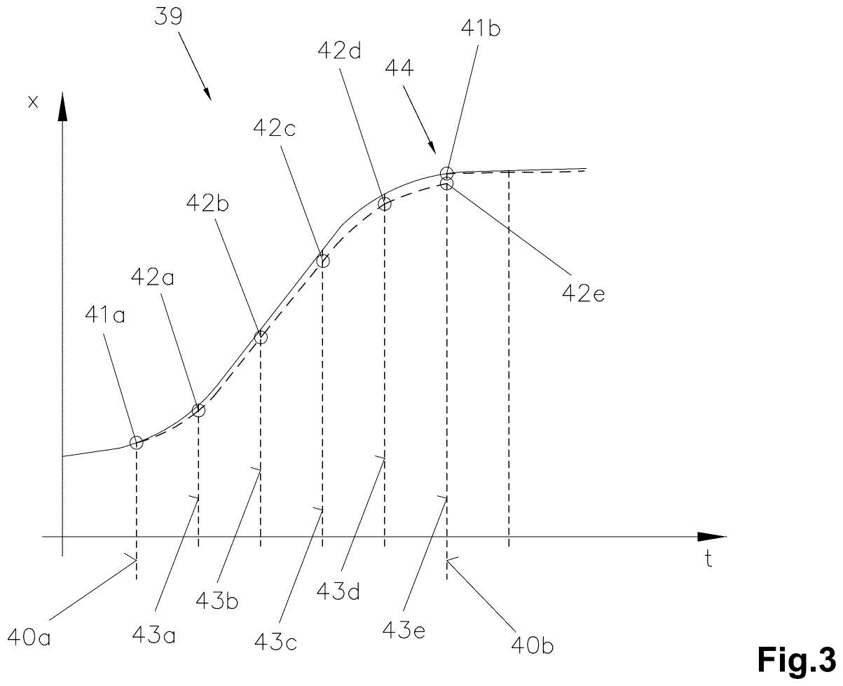

In order to now activate the laser 5,6 in time or to generate a control signal for the laser control, an estimate 39 or calculation 39 of the system states, in particular the estimate 39 of the position of the focusing unit 12, is made at future points in time between two sampling times 40 or sampling cycles 40, as shown schematically in FIG. 3. Here, the path or position calculated according to the path planning is plotted in full lines, and the estimate 39 of the path or position is plotted in dashed lines in a position-time diagram.

Starting from a current point in time, i.e. the first sampling time 40a, the known or measured axle position 41a, which is transmitted from the axle module 29, 30 to the laser control module 31 or the universal board, in particular the Universal Trotec Board, at the sampling time 40a, is used and then an estimate 39 or calculation 39 for unknown future axle positions 42a-e at future points in time 43a-e up to the next sampling time 40b is carried out. When the next sampling cycle 40b or sampling time 40 is reached, in turn a known or measured axle position 41b is transmitted from the axle module 29, 30 to the laser control module 31 or the Universal Board, in particular the Universal Trotec Board, and used as an initial value for a new estimate 39. Here, at the start of the simulation period the estimate 39 precisely matches the measurement or the transmitted axle position 41, whereby a difference between the planned axle position and the simulated axle position 42 arises as the simulation time progresses. However, since a known or measured value or axle position 41 is transmitted again after the sampling time 40 has elapsed and is transmitted for a new simulation or axle position 41 and used as the initial value for a new simulation or estimate 39, the difference is automatically corrected after each sampling cycle 40. The estimate 39 is based on a mathematical-physical model of the mechatronic axle system including the control unit, which includes the relevant properties and effects such as geometry, inertia, friction, elasticity, quantization of the position measurement, time delay of the processing, closed control loop, and path planning. This model is described mathematically e.g. by a set of differential equations. For example, a system of equations may be used for the purpose of estimating 39 or calculating 39 the future axle positions 42 by a time integration method, in particular an explicit numerical time integration method such as the Runge-Kutta 4 method used. For the sake of completeness, it is mentioned that the estimate 39 is performed directly by the laser control module 31 or the universal board, in particular the Universal Trotec Board.

Due to the laser 5,6 used with a laser frequency of e.g. 200 kHz, 40 different position estimates 42 or estimated axle positions 42 can be determined in the best case with a sampling time 40 of 200 μs, i.e. that an estimate 39 of the estimated axle position 42 is calculated for all 5 μs. Of course, it is also possible here to provide fewer than 40 estimates 39 for the sampling time 40 of 200 μs. Merely for illustration, FIG. 3 shows an exemplary embodiment in which only 5 estimates 39 of the axle position 42a-e within two sampling times 40a,b of 200 μs are provided, whereby the actual measured axle position 41 is always transmitted at the sampling times 40. The advantage here is that the measured axle position 41 and the next axle position 44 are always transmitted by the path planning at the sampling times 40, i.e. the transmitted axle position 41 represents the initial state at the beginning of the estimate 39 and the second desired axle position 44 according to the path planning at the end of the estimate 39, whereby the further position estimates 39 of the axle positions 42 lying in between are determined by integration, in particular of the Runge-Kutta 4 method, so that the laser control module 31 or the universal board, in particular the Universal Trotec Board, is informed in good time by the planned or estimated axle position 42 and can thus activate the laser 5, 6 in good time so that it is fired in the desired end position.

The estimate 39 of the axle positions 42 is important insofar as the firing of the laser 5,6 requires a fraction of the time or time intervals in which the measured axle positions 41 are transmitted according to the sampling cycles 40 or sampling times 40. Thus, due to the estimate 39 of the axle positions 42 at future shorter points in time 43, a synchronization of the laser 5, 6 with the estimated axle position 42 is practically realized, so that the laser 5, 6 can be activated via a control signal at an estimated axle position 42, so that the laser beam 10 is applied to the workpiece 7 at the correct point in time 43 and axle position 42. Here, a resolution of the estimates 39 made, i.e. the number of estimates 39, can be set, whereby the best possible resolution is achieved with a maximum achievable estimate 39 of 40, since the laser 5,6 is practically activated with the last estimate 39, for example, and is therefore ready for operation at the right time. If, on the other hand, fewer estimates 39 are made or set, the laser 5,6 is activated slightly too early.

The estimates 39 ensure that the time period between two sampling times 40, or the time intervals in which no values are available for the axle positions, is shortened, with corresponding estimates 39 of the axle positions 42 being made at defined points in time 43. This ensures that the laser control module 31 or the universal board, in particular the Universal Trotec Board, is constantly informed of the position of the focusing unit 12 on the basis of the estimated axle positions 42, so that the control signal for the laser 5, 6 is activated according to a specific position so that the laser beam 10 impacts on the workpiece 7 to be processed at the desired position.

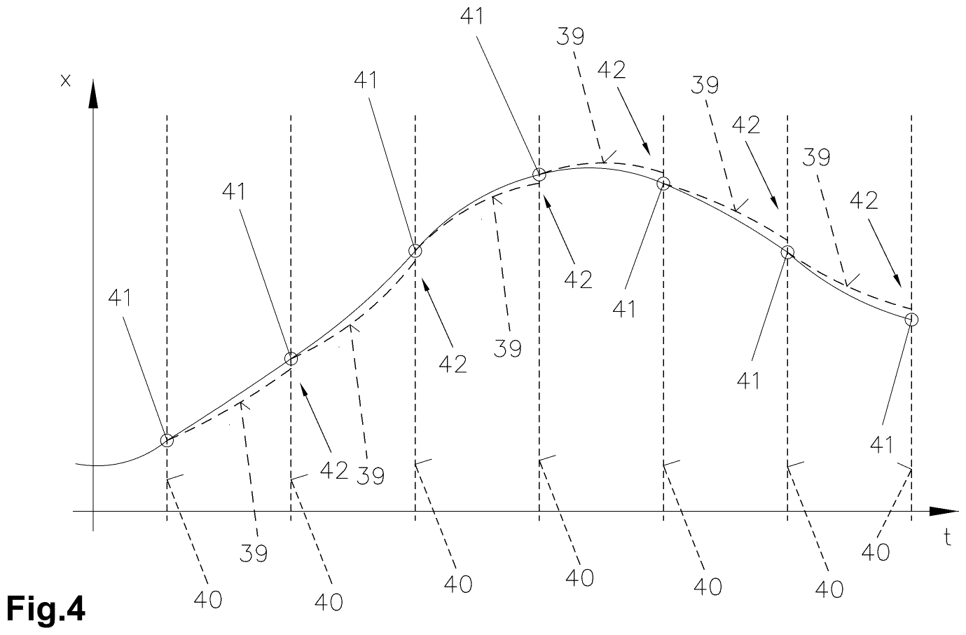

Furthermore, FIG. 4 shows a position-time diagram with several paths or positions of the path planning and the corresponding estimate 39 of the axle position 42 with dashed lines, whereby several consecutive sampling time intervals are plotted. Here it is essential that the control signal for the irradiation source 4, in particular the laser 5, 6, is synchronized with the position of the focusing unit 12 for correct control of the irradiation source 4, in particular the laser 5, 6, during processing, in particular in engraving mode, which is achieved by estimating 39 or calculating the axle positions 42 between the sampling times 40. Furthermore, it can be seen that at each sampling time 40 the transmitted axle position 41 is used for a new estimate 39, i.e. at the start of an estimate 39 the transmitted axle position 41, in particular that measured by the position sensor 35, 36, is used, so that any differences arising between the measured axle position 41 and the estimated axle position 42 are kept to a minimum. For the sake of completeness, it is mentioned that in the estimates 39 no individual axle positions 42 with the points in time 43, as shown in FIG. 3, were entered in FIG. 4 for the sake of clarity.

As a matter of principle, it can be said that according to the present disclosure, a method for operating a laser plotter 1 for cutting, engraving, marking and/or lettering a workpiece 7 is disclosed, in which at least one irradiation source 4 in the form of a laser 5, 6 is used in a housing 3 of the laser plotter 1, where when the irradiation source 4 is activated, a laser beam 10 is directed via deflection elements 11 to a focusing unit 12, where a control unit 13 performs the control on the basis of the set parameters and/or a loaded job, where preferably a processing table 9 or processing chamber 8 is detected by at least one camera 23 for picking up an inserted workpiece 7, where the data, in particular job 18, are received via a preferably Windows-based computer unit 27, whereupon a calculation of the path planning is performed offline by the computer unit 27 or externally by a cloud solution or component 15, whereupon the path planning and further data are transferred to a PLC controller 26a or soft PLC 26b, from which the individual target data are then sent step by step via an industrial bus 25, in particular an EtherCat bus, to the modules 29, 30, 31 for the axle control and laser control, whereby at cyclical sampling times 40, in particular every approx. 200 μs, the acquired position and speed information 41 is transmitted from the axle control or the axle modules 29,30 to the laser control or laser control module 31, whereupon the laser control module 31 performs an estimate 39 or calculation 39 of one or several axle positions 42 at future points in time 43 in order to activate or trigger a control signal for the laser control in good time, in particular for activating the laser source or laser 5, 6 at the predetermined position of the focusing unit 12.

To this end, the laser plotter 1 is designed for engraving, marking and/or lettering a workpiece 7, which includes a processing chamber 8 for positioning a workpiece 7, at least one, preferably two irradiation sources 4 in the form of lasers 5, 6, corresponding deflection elements 11, a preferably movable focusing unit 12 and a control unit 13 for controlling a carriage 14 operated preferably via a belt drive with a focusing unit 12 movably arranged thereon, where a computer unit 27 is arranged for the transfer and processing of data, in particular jobs 18 or graphics 16 and/or text 16, which is connected to a PLC control 26a or soft PLC 26b, where at least one axle module 29, 30 and one laser control module 31 are connected to the PLC control 26a or soft PLC 26b via an industrial bus 25, 28, where the laser control module 31 is used for estimate 39 or calculation 39 of future axle positions 42 at future points in time 43 based on recorded position and speed information, in particular the axle positions and speeds of the axle modules 29, 30, whereupon a laser 5, 6 can be activated at a correspondingly defined axle position 42.

It is essential for the proper functioning of the individual modules 29, 30, 31, in particular the laser control module 31, that all slave clocks run synchronously with the master clock. To this end, synchronization information is emitted by the master.

A soft PLC 26b (programmable logic controller in software 26b) is a software program that emulates a conventional programmable logic controller (PLC controller 26a). This includes functionality as well as non-functional aspects such as robustness and real-time behavior. A soft PLC 26b includes at least one PC—usually an industrial PC, embedded PC or box PC—, a PLC software, and the I/O modules and/or industrial bus. The soft PLC 26b is or can be integrated into the computer unit 27.

A PLC controller 26a (programmable logic controller 26a) is a device that is used to control or regulate a machine or system and is programmed on a digital basis. In the simplest case, a PLC controller 26a has inputs, outputs, an industrial bus, an operating system, and an interface via which the user program can be loaded. A PLC controller 26a can be implemented in a wide variety of ways, e.g. as a single device (“subassembly”), as a PC plug-in card, as software emulation, etc.

For the sake of completeness, it is mentioned that path planning is usually carried out “offline”, i.e. before the work or marking process, although it is also possible that the work or marking process starts or is executed while the path planning has not yet been completed, i.e. that the work or marking process starts with a time delay to the path planning during the calculation.

As a matter of principle, it can be said that the path planning corresponds to the real movement sequence, whereas the estimate corresponds to the simulated positions. It is also possible that the solution according to the present disclosure can also be applied and used with other laser machines, in particular with a galvo laser or galvo marking laser.

The present disclosure is not limited to the embodiments shown, but may also include other designs and structures.

1. A method for operating a laser plotter for cutting, engraving, marking and/or lettering a workpiece, in which at least one irradiation source in the form of a laser is used in a housing of the laser plotter, wherein, when the at least one irradiation source is activated, a laser beam is directed via deflection elements to a focusing unit, wherein a control unit performs control on a basis of a set parameters and/or a loaded job, wherein a processing table for a processing chamber is detected via at least one camera for recording an inserted workpiece, wherein data is received via a computer unit and a calculation of a path planning is carried out offline by the computer unit or externally by a cloud solution or component, whereupon the path planning and further data are transmitted to a programmable logic controller (PLC), from which at sampling times, the path planning and further data, including a speed, are then sent step by step via an industrial bus to at least devices for axle control and laser control, wherein at least an acquired position and speed information are sent from the axle control device to the laser control device at the sampling times, whereupon an estimate of one or several future axle positions at future points in time is performed by the laser control in order to activate a control signal for the laser control device for activating the laser at a predetermined estimated axle position of the focusing unit.

2. The method according to claim 1, wherein the axle control device cyclically transfers or transmits position and speed data received from a position sensor and a next upcoming axle position according to the calculated path planning to the laser control device via the industrial bus at the sampling times.

3. The method according to claim 1, wherein the laser control device performs a calculation or estimate of several future system states, including the future axle position at future points in time, on a basis of a numerical time integration method based on the data transmitted by the axle control device.

4. The method according to claim 3, wherein a number of future calculated estimates, including the calculated axle positions (42) at future calculated points in time, is adjustable.

5. The method according to claim 1, wherein at the beginning of a simulation period, the estimate of axle position exactly matches a measurement or a transmitted axle position, whereby a difference between a planned axle position and a simulated axle position arises as simulation time progresses.

6. The method according to claim 5, wherein the difference is automatically corrected by adopting a measured or known axle position at each sampling time.

7. The method according to claim 1, wherein a time of the PLC controller is synchronized with a time of the axle control device the laser control device.

8. The method according to claim 1, wherein the sampling time for the industrial bus used is between 150 μs and 300 μs.

9. The method according to claim 1, wherein the time interval between the points in time for the estimate of the axle position, including a plurality of points in time, is smaller than the time interval between the sampling times is.

10. The method according to claim 1, wherein a deviation of the estimate of the axle position depends on an accuracy of the measurement of the initial state, on a choice of the effects taken into account in the model, on an accuracy of the numerical values used for the model parameters for, among other things, geometry, inertia, friction and elasticity, and on a duration of the simulation.

11. The method according to claim 1, wherein, at the sampling times, a result of the path planning, including position, speed, acceleration, and laser power, is transmitted.

12. A laser plotter for engraving, marking and/or lettering a workpiece, comprising a processing chamber for positioning a workpiece, at least one irradiation source in the form of a laser, corresponding deflecting elements, a movable focusing unit and a control unit for controlling a carriage operated via a belt drive and having a focusing unit arranged movably thereon, wherein a computer processor is arranged for transfer and processing of data, wherein the computer processor is connected to a programmable logic controller (PLC), wherein at least one axle control device and one laser control device are connected to the PLC via an industrial bus, wherein the laser control device is used for estimate or calculation of future axle positions at future points in time based on recorded position and speed information, including axle positions and speeds of the axle control device, whereupon the laser can be activated at a correspondingly defined axle position.

13. The laser plotter according to claim 12, wherein a position transmitter is arranged on the axle control device.

14. The laser plotter according to claim 12, wherein the computer processor is integrated into the laser plotter.
